(19) United States
(12) Patent Application Publication
(10) Pub. No.: US 2025/0350649 A1
(43) Pub. Date: Nov. 13, 2025

(54) SIGNALING AUGMENTED REALITY SUPPORT BY CLIENT DEVICES FOR AR COMMUNICATION SESSIONS

(71) Applicant: QUALCOMM Incorporated, San Diego, CA (US)

(72) Inventors: Imed Bouazizi, Celina, TX (US); Liangping Ma, San Diego, CA (US); Thomas Stockhammer, Bergen (DE)

(21) Appl. No.: 19/204,916

(22) Filed: May 12, 2025

Related U.S. Application Data
(60) Provisional application No. 63/646,352, filed on May 13, 2024.

(51) Int. Cl. H04L 65/1069; G06T 15/00; H04L 65/1016; H04L 65/1089; H04L 65/1104

(52) U.S. Cl. CPC H04L 65/1069; G06T 15/00; H04L 65/1016; H04L 65/1089; H04L 65/1104

(57) ABSTRACT

An example first client device for communicating media data via a radio access network (RAN) includes: a memory configured to store AR media data; and a processing system implemented in circuitry and configured to: send data to a network device of the RAN, the data indicating an amount of support for AR processing provided by the first client device; establish an AR communication session with a second client device; and exchange AR media data with the second client device according to the amount of support for AR processing provided by the first client device.

This application claims the benefit of U.S. Provisional Application No. 63/646,352, filed May 13, 2024, the entire contents of which are hereby incorporated by reference.

### TECHNICAL FIELD

This disclosure relates to transport of media data, and more particularly, to split rendering of augmented reality media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for performing split rendering of augmented reality (AR) media data. In particular, various client devices may support various degrees of AR rendering for AR communication sessions. There may be three types of client devices that may participate in AR communication sessions: those that are fully AR-capable, those that are not AR capable at all, and those that are partially AR-capable. Fully AR-capable client devices may have no need for split rendering (i.e., rendering by an intermediate device). Client devices that are not AR capable at all and client devices that are partially AR capable may require an intermediate device to partially or fully render AR media data of the AR communication session in order to participate. A client device per the techniques of this disclosure may signal the amount of support for AR processing by the client device, and to configure an intermediate device to partially or fully render AR media data when the client device does not support full AR rendering.

In one example, a method of communicating augmented reality (AR) media data includes: sending, by a first client device that is communicatively coupled to a radio access network (RAN), data to a network device of the RAN, the data indicating an amount of support for AR processing provided by the first client device; establishing, by the first client device, an AR communication session with a second client device; and exchanging, by the first client device, AR media data with the second client device according to the amount of support for AR processing provided by the first client device.

In another example, a first client device for communicating media data via a radio access network (RAN) includes: a memory configured to store AR media data; and a processing system implemented in circuitry and configured to: send data to a network device of the RAN, the data indicating an amount of support for AR processing provided by the first client device; establish an AR communication session with a second client device; and exchange AR media data with the second client device according to the amount of support for AR processing provided by the first client device.

In another example, a first client device for communicating media data via a radio access network (RAN) includes: means for sending data to a network device of the RAN, the data indicating an amount of support for AR processing provided by the first client device; means for establishing an AR communication session with a second client device; and means for exchanging AR media data with the second client device according to the amount of support for AR processing provided by the first client device.

In another example, a method of communicating augmented reality (AR) media data includes: receiving, by an AR application server (AS) device, a request from a first client device to participate in an AR communication session with a second client device, the request including data indicating an amount of support for AR processing provided by the first client device; determining, based on the amount of support for AR processing indicated by the data of the request, whether to invoke at least partial rendering of the AR media data on behalf of the first client device; and in response to determining to invoke the at least partial rendering of the AR media data, at least partially rendering the AR media data on behalf of the first client device and sending the at least partially rendered AR media data to the first client device.

In another example, an augmented reality (AR) application server (AS) device for communicating media data includes: a memory configured to store AR media data; and a processing system implemented in circuitry and configured to: receive a request from a first client device to participate in an AR communication session with a second client device, the request including data indicating an amount of support for AR processing provided by the first client device; determine, based on the amount of support for AR processing indicated by the data of the request, whether to invoke at least partial rendering of the AR media data on behalf of the first client device; and in response to determining to invoke the at least partial rendering of the AR media data, at least partially render the AR media data on behalf of the first client device and send the at least partially rendered AR media data to the first client device.

In another example, an augmented reality (AR) application server (AS) device for communicating media data includes: means for receiving a request from a first client device to participate in an AR communication session with a second client device, the request including data indicating an amount of support for AR processing provided by the first client device; means for determining, based on the amount of support for AR processing indicated by the data of the request, whether to invoke at least partial rendering of the AR media data on behalf of the first client device; and means for at least partially rendering the AR media data on behalf of the first client device in response to determining to invoke the at least partial rendering of the AR media data; and means for sending the at least partially rendered AR media data to the first client device in response to determining to invoke the at least partial rendering of the AR media data.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques of this disclosure.

FIG. 3 is a flow diagram illustrating an example avatar animation workflow that may be used during an augmented reality (AR) session.

FIG. 4 is a flow diagram illustrating an example AR session between two user equipment (UE) devices and a shared space server device.

FIG. 5 is a block diagram illustrating an example user equipment (UE).

FIG. 6 is a block diagram illustrating an example set of devices that may perform various aspects of the techniques of this disclosure.

FIG. 7 is a conceptual diagram illustrating an example set of data that may be used in an AR session per techniques of this disclosure.

FIG. 8 is a flowchart illustrating an example method of performing split rendering according to techniques of this disclosure.

FIG. 9 is a flowchart illustrating an example method for communicating augmented reality (AR) media data according to techniques of this disclosure.

FIG. 10 is a flowchart illustrating an example method for communicating augmented reality (AR) media data according to techniques of this disclosure.

### DETAILED DESCRIPTION

In general, this disclosure describes techniques for performing split rendering of augmented reality (AR) media data or other extended reality (XR) media data, such as mixed reality (MR) or virtual reality (VR). A split rendering server may perform at least part of a rendering process to form rendered images, then stream the rendered images to a display device, such as AR glasses or a head mounted display (HMD). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. The display device may then receive rendered media for display from the split rendering server. The XR runtime may be configured to receive rendered data together with associated pose information (e.g., information indicating the predicted pose for which the rendered data was rendered) for proper composition and display. For instance, the XR runtime may need to perform pose correction to modify the rendered data according to an actual pose of the user at the display time. This disclosure describes techniques for conveying render pose information together with rendered images, e.g., in the form of a Real-time Transport Protocol (RTP) header extension. In this manner, the display device can accurately correct and display rendered images when the images were rendered by a separate device, e.g., for split rendering. This may allow advanced rendering techniques to be performed by the split rendering server while also presenting images that accurately reflect a user pose (e.g., position and orientation/rotation) to the user.

In general, there are three types of devices that may participate in an AR communication session: those that have full AR capability and can render 3D scenes; those that are at least partially AR-capable but may lack the ability to perform full 3D rendering (e.g., due to lacking necessary rendering capabilities or resources, such as battery power, processing power, or the like); and those that are completely AR incapable. Client devices that are partially AR capable or fully AR incapable may request network-based rendering to participate in an AR call. A client device with partial support can benefit from an AR (or extended reality (XR)) experience through sharing pose information and rendering content on a head-mounted display (HMD). An AR-unaware/incapable client device may require a network device to automatically perform network rendering on its behalf, but see only a 2D view with no XR experience. It is important for a client device to be able to send information indicating the degree of AR support provided by the client device, and for the network to receive such information in order to determine whether and an amount of AR rendering to perform on behalf of the client device.

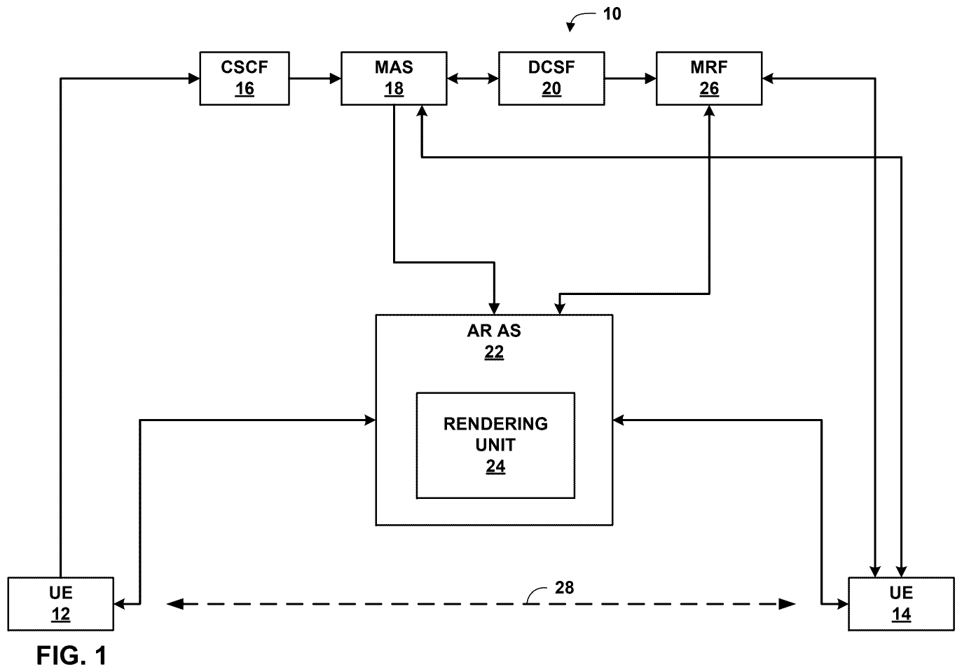

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (MRF) 26, and augmented reality application server (AR AS) 22. MAS 18 may correspond to a multimedia telephony application server, an IP Multimedia Subsystem (IMS) application server, or the like.

UEs 12, 14 may also include an AR multimedia telephony service over IMS (AR-MTSI) client. UEs 12, 14 may include an AR-MTSI client in terminal, that is, an AR-MTSI client that is implemented in a terminal.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. AR media data may include audio, video, text, image, or other such data, which may include 2D and/or 3D media data. UEs 12, 14 may also exchange AR metadata that provides information on the AR media data and its rendering, e.g., pose, spatial descriptions, and scene descriptions. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QOS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session. MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit 24 is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams, such as media content 64, that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data (e.g., media content 64) and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

According to techniques of this disclosure, UE 14, for example, may communicate with rendering unit 24 to indicate support of UE 14 for AR calls. That is, UE 14 may indicate an amount of support for AR calls that is implemented in UE 14, such as full support, partial support, or no support.

In particular, UEs 12, 14 may include an AR-MTSI client in terminal. The AR-MTSI client in terminal of, e.g., UE 14 may indicate support for AR calls by including a “webrtc-datachannel” value in a “+sip.sub-type” in a SIP feature tag of a contact header field. The AR-MTSI client in terminal of UE 14 may use a “+csip.3gpp-ar-support” parameter of the contact header field, per the techniques of this disclosure, to indicate a level of support for AR calls provided by the AR-MTSI client in terminal.

One potential value for the “3gpp-ar-support” parameter includes “ar-full,” which indicates that the AR-MTSI client in terminal is fully capable of receiving and rendering AR media. For example, “ar-full” may indicate that the AR-MTSI client in terminal is capable of receiving and rendering AR media data conforming to glTF2.0 scene description files, MPEG-I scene description documents, and/or glTF2.0 extensions, e.g., as defined in 3GPP TS 26.119 v. 18.0.0, “3^{rd} Generation Partnership Project; Technical Specification Group Services and System Aspects; Device Media Capabilities for Augmented Reality Services (Release 18),” March, 2024, section 9.2.

Another potential value for the “3gpp-ar-support” parameter includes “ar-partial,” which indicates that the AR-MTSI client in terminal is capable of transmitting AR metadata on the uplink, but that the UE does not have support for processing and rendering a 3D scene (or that the UE will finalize rendering following partial rendering). The participation in the AR call may therefore require deployment of network rendering. Rendered view(s) may be controlled by the pose information that is shared by the AR-MTSI terminal.

Still another potential value for the “3gpp-ar-support” parameter includes “ar-none,” which indicates that the AR-MTSI client in terminal has no support for AR calls. Thus, participation in an AR call requires network rendering. The rendered view may be a 2D view that is determined by the MF/MRF (e.g., MRF 26) performing network rendering

In the absence of the “+sip.3gpp-ar-support,” the “ar-none” value may be assumed.

When the AR-MTSI terminal of UE 14 is to participate in an AR call, the AR-MTSI terminal of UE 14 may register with the “ar-full” value for the “+sip.3gpp-ar-support” parameter and may offer/answer an SDP that includes a data channel with the sub-protocol “mpeg-sd.” The AR-MTSI terminal of UE 14 may share updates, such as pose updates, in the form of scene updates to AR AS 22.

Alternatively, when the AR-MTSI terminal of UE 14 is to participate in an AR call with support for network rendering, the AR-MTSI terminal of UE 14 may register with the “ar-partial” value for the “+sip.3 gpp-ar-support” parameter and may offer/answer an SDP that includes a data channel with the sub-protocol “3gpp-sr-metadata.” The AR-MTSI terminal of UE 14 may share pose updates that are to be used for rendering as pose predictions with MRF 26.

As specified in Annex AC.9 of TS 23.228, AR AS 22 may provide network assisted rendering, e.g., using rendering unit 24. An AR-MTSI client in terminal (e.g., of UE 14) may request network media rendering based on status such as power, signal, computing power, internal storage, or the like. The AR-MTSI client in terminal of UE 14 may complete an AR media rendering negotiation with AR AS 22 before initiating subsequent procedures to activate the network media rendering.

An AR-capable terminal that is to deploy network rendering for AR media rendering may use the negotiation process between the AR-MTSI client in terminal and AR AS 22 to determine the split-rendering configuration. The split-rendering configuration may be in JavaScript Object Notation (JSON) format as specified in clause 8.4.2 of TS 26.565. The exchange of the configuration information may take place using an established MTSI data channel. The split rendering configuration message may be formatted according to clause 8.4.2.2 of TS26.565 and have the type: “urn:3gpp:split-rendering:v1: configuration.” The output description message may be formatted according to clause C.1.4 of TS26.565 and have the type: “urn: 3gpp: split-rendering:v1:output.”

For a terminal that does not support AR calls, the IMS AS may trigger network rendering on behalf of the terminal in response to receiving an INVITE or reinvite for an AR call. The output format for the rendered media may conform to the 2D Pixel Streaming Profile in clause C.1.2 of TS26.565. MRF 26, which may perform remote rendering, may select a suitable rendering viewpoint for the session, e.g., a selected viewpoint in the scene or the initial viewpoint for the participant as assigned by AR AS 22 in the scene description.

The IMS AS may detect support for AR capabilities based on the “+sip.3gpp-ar-support” parameter of the Contact Header Field as discussed above. In this manner, a SIP feature tag in a contact header field may include data indicating a level of support for AR processing.

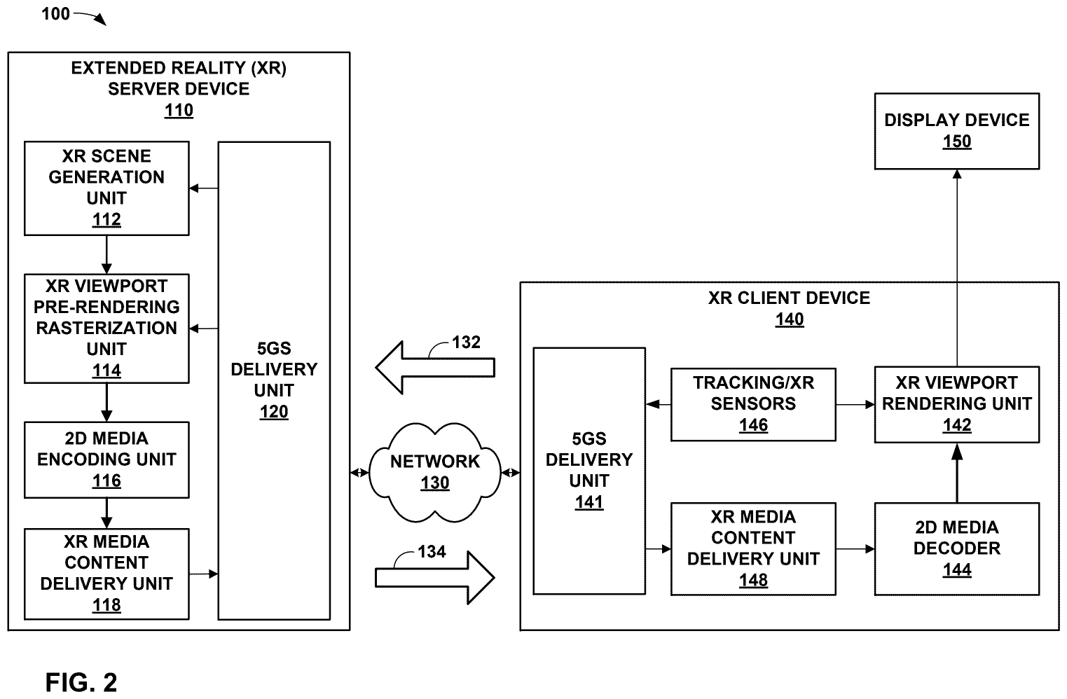

FIG. 2 is a block diagram illustrating an example computing system 100 that may perform split rendering techniques of this disclosure. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular er/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

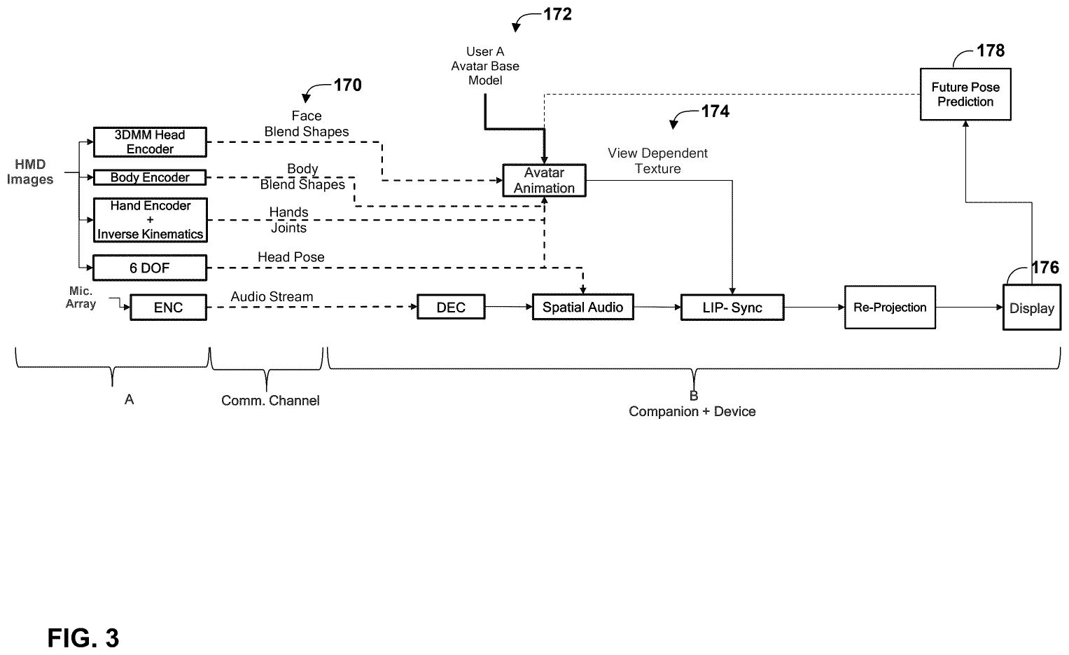

FIG. 3 is a flow diagram illustrating an example avatar animation workflow that may be used during an AR session. In this example, received animation stream data 170 includes face blend shapes, body blend shapes, hand joints, head pose, and audio stream data. The face blend shapes, body blend shapes, and hand joints may correspond to animation streams to be applied to user A avatar base model 172. In particular, data for user A avatar base model 172 may be stored at various levels of detail, per the techniques of this disclosure. Thus, rendering components 174 may retrieve data of user A avatar base model 172 at an appropriate level of detail, e.g., based on a distance between a current user and user A in a 3D space. Rendering components 174 may then animate the avatar base model using received animation stream data 170. Ultimately, the animated avatar base model may be presented to the current user via display 176. In addition, movement data of the current user may be used to predict a future pose of the user by future pose prediction unit 178.

In some examples, display 176 and future pose prediction unit 178 may be included in a device that is not capable of fully rendering AR media data. For example, display 176 may correspond to display device 150 of FIG. 2, and future pose prediction unit 178 may correspond to tracking/XR sensors 146 of XR client device 140 of FIG. 2. Thus, per techniques of this disclosure, the various rendering units of FIG. 3 may be included in a network device, such as an edge application server (EAS) device, an MF/MRF device, or the like, such as XR server device 110 of FIG. 2. For example, XR server device 110 may perform the functionality attributed to rendering of AR media data, such as rendering components 174 of FIG. 3.

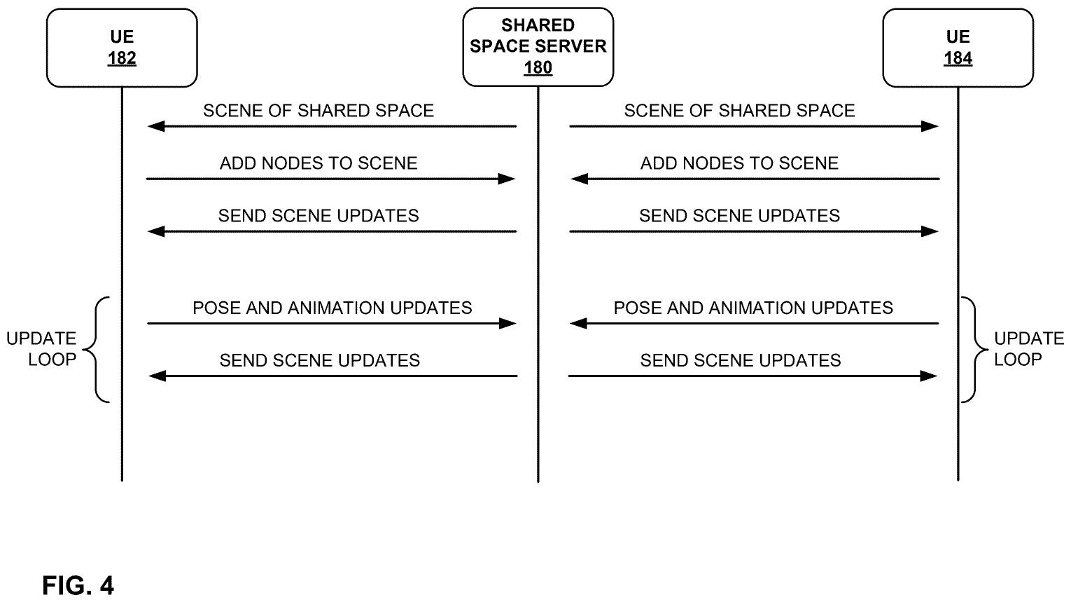

FIG. 4 is a flow diagram illustrating an example AR session between two user equipment (UE) devices and a shared space server device. As shown in the example of FIG. 4, two or more UEs may participate in an AR media communication session. The UEs may send and receive data representative of their animation streams and other 3D model data to and from a shared space server. For example, various sensors such as cameras, trackers, LIDAR, or the like, may track user movements, such as facial movements (e.g., during speech or as emotional reactions), hand movements, walking movements, or the like. These movements may be translated into an animation stream by, e.g., UE 182 and sent to the shared space server. The shared space server may then send the animation stream to UE 184.

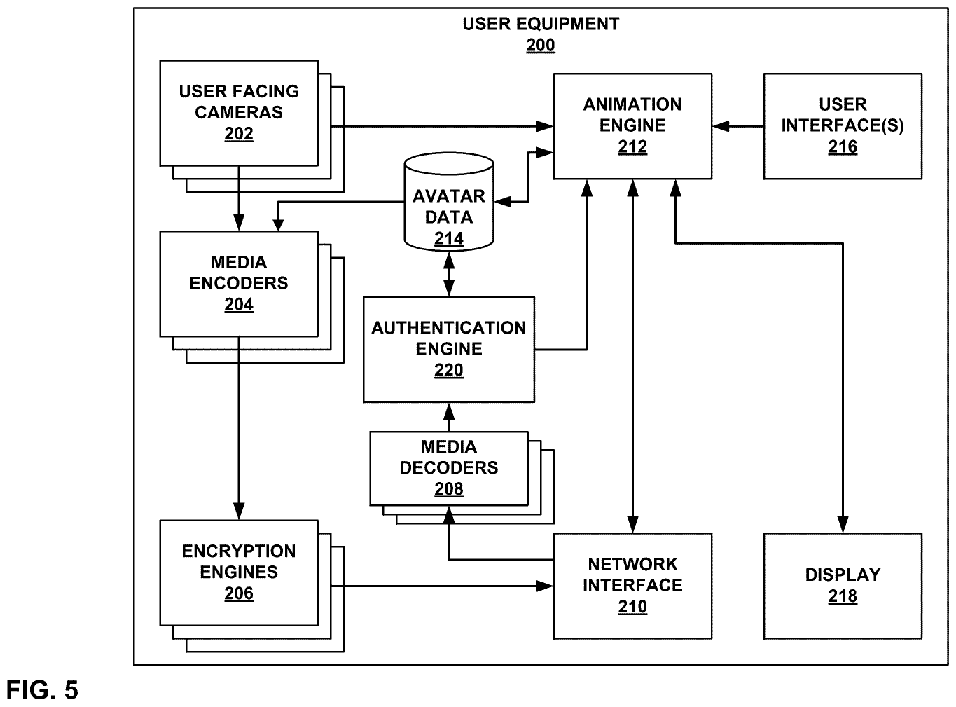

FIG. 5 is a block diagram illustrating an example user equipment (UE) 200. UEs 12, 14 of FIG. 1 may include components similar to those of UE 200. In general, a participant device may both send and receive content during an AR communication session. In this example, UE 200 includes user facing cameras 202, video encoders 204, encryption engines 206, media decoders 208, network interface 210, authentication engine 220, avatar data 214, animation engine 212, user interface(s) 216, and display 218.

A user may use UE 200 to participate in an AR communication session, e.g., to both send and receive AR data with one or more other participants in the AR communication session. For example, UE 200 may receive inputs from the user via user interface(s) 216, which may correspond to buttons, controllers, track pads, joysticks, keyboards, sensors, or the like. Such inputs may represent, for example, movements of the user in real-world space to be translated into the virtual scene, such as locomotive movement, head movements, eye movements (captured by user facing cameras 202), or interactions with the various buttons or other interface devices.

Animation engine 212 may receive such inputs and determine how to animate a user's avatar, stored in avatar data 214. For example, such animations may include locomotive animations (walking or running), arm movement animations, hand movement animations, finger movement animations, and/or facial expression change animations. Animation engine 212 may provide animation information to network interface 210 for output to other participants in the AR communication session, along with other information such as, for example, interactions with virtual objects, movement direction, viewport, or the like.

In addition, user facing cameras 202 may provide one or more video streams of a user's face to video encoder(s) 204 to form an encoded video stream, which may be encrypted by encryption engine(s) 206 or sent unencrypted. When the user is wearing a head-mounted display (HMD), the HMD may be configured to capture only parts of the user's face by user-facing cameras 202 of the HMD (e.g., eyes and mouth may be captured as three distinct streams). Such video streams (which may further be encrypted) may be provided to network interface 210 and sent to other participants in the AR communication session, such that the UEs of the other participants can authenticate that the avatar data is actually coming from the user of UE 200, per the techniques of this disclosure.

Similarly, UE 200 may receive encrypted video stream(s) from the other participants in the AR communication session. UE 200 may decrypt and then decode the video stream(s) using media decoders 208, which may provide the decrypted video streams to authentication engine 220. Authentication engine 220 may authenticate use of an avatar of the other user prior to rendering the avatar. When the other user is authenticated to use the avatar, animation engine 212 may provide an animated version of the base avatar to be displayed to a user of user equipment 200 via display 218.

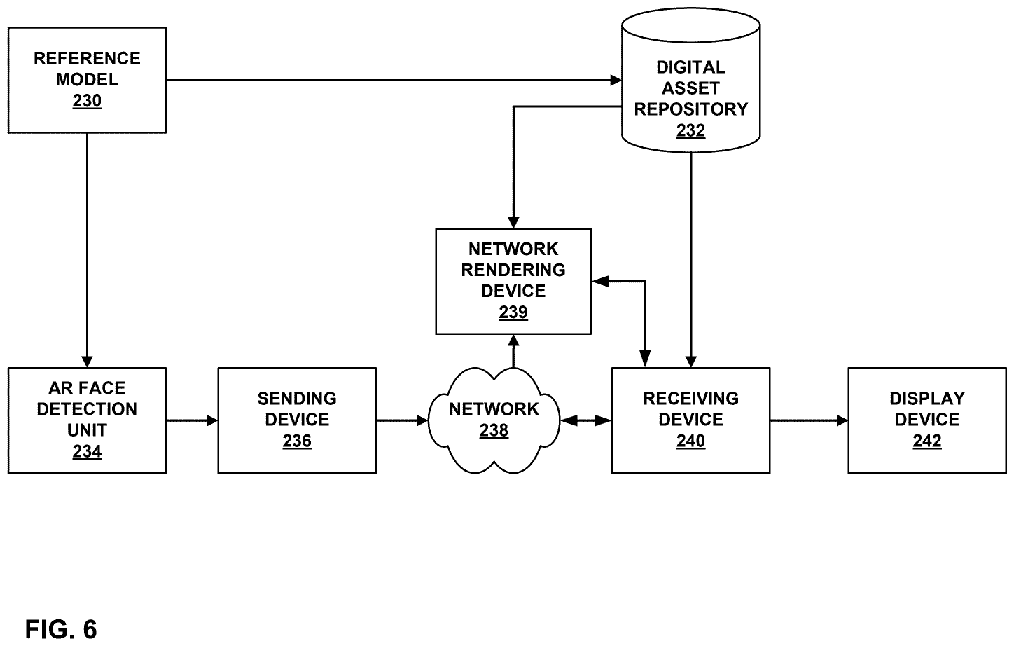

FIG. 6 is a block diagram illustrating an example set of devices that may perform various aspects of the techniques of this disclosure. The example of FIG. 6 depicts reference model 230, digital asset repository 232, AR face detection unit 234, sending device 236, network 238, network rendering device 239, receiving device 240, and display device 242. Sending device 236 may correspond to UE 12 of FIG. 1, and receiving device 240 may correspond to UE 14 of FIG. 1 and/or XR client device 140 of FIG. 2.

Sending device 236 and receiving device 240 may represent user equipment (UE) devices, such as smartphones, tablets, laptop computers, personal computers, or the like. AR face detection unit 234 may be included in an AR display device, such as an AR headset, which may be communicatively coupled to sending device 236. Likewise, display device 242 may be an AR display device, such as an AR headset.

In this example, reference model 230 includes model data for a human body and face. Digital asset repository 232 may include avatar data for a user, e.g., a user of sending device 236. Digital asset repository 232 may store the avatar data in a base avatar format. The base avatar format may differ based on software used to form the base avatar, e.g., modeling software from various vendors.

AR face detection unit 234 may detect facial expressions of a user and provide data representative of the facial expressions to sending device 236. Sending device 236 may encode the facial expression data and send the encoded facial expression data to network rendering device 239 and receiving device 240 via network 238. Network 238 may represent the Internet or a private network (e.g., a VPN). Network rendering device 239 and receiving device 240 may decode and reconstruct the facial expression data and use the facial expression data to animate the avatar of the user of sending device 236.

In particular, per techniques of this disclosure, receiving device 240 may send data to network rendering device 239 via network 238 indicating support for AR processing. That is, receiving device 240 may indicate whether receiving device 240 is fully, partially, or incapable of rendering AR media data. Network rendering device 239 may thus determine whether to fully or partially render AR media data destined for receiving device 240. Network rendering device 239 may be an AR AS device, an MF/MRF device, or other such device that performs split rendering on behalf of receiving device 240.

Furthermore, when receiving device 240 is not fully capable of rendering AR media data, receiving device 240 may send predicted pose information to network rendering device 239. Thus, receiving device 240 may render AR media data according to the predicted pose information. Likewise, in some examples, receiving device 240 may determine an actual pose for the rendered AR media data, then warp the rendered AR media data according to differences between the predicted pose and the actual pose.

Various facial and body tracking units may perform facial and body tracking in different ways, which may vary widely according to a solution being sought. For example, various facial and body tracking units may be configured with different numbers of blendshapes with different sets of expressions and/or different rigs (that is, 3D models of joints and bones) with different sets of bones and joints and different bone dimension. Some facial expressions and bones/joints do not exist in certain solutions but do exist in other solutions.

This variation in 3D object model representations can lead to interoperability challenges. For example, sending device 236 may use a first framework to track face and body movements of a user, while receiving device 240 may use a base avatar of the user of sending device 236 that is based on a different set of facial expressions and body skeleton. This disclosure describes techniques for enabling avatar animation when different tracking frameworks are used for the base model and movement tracking.

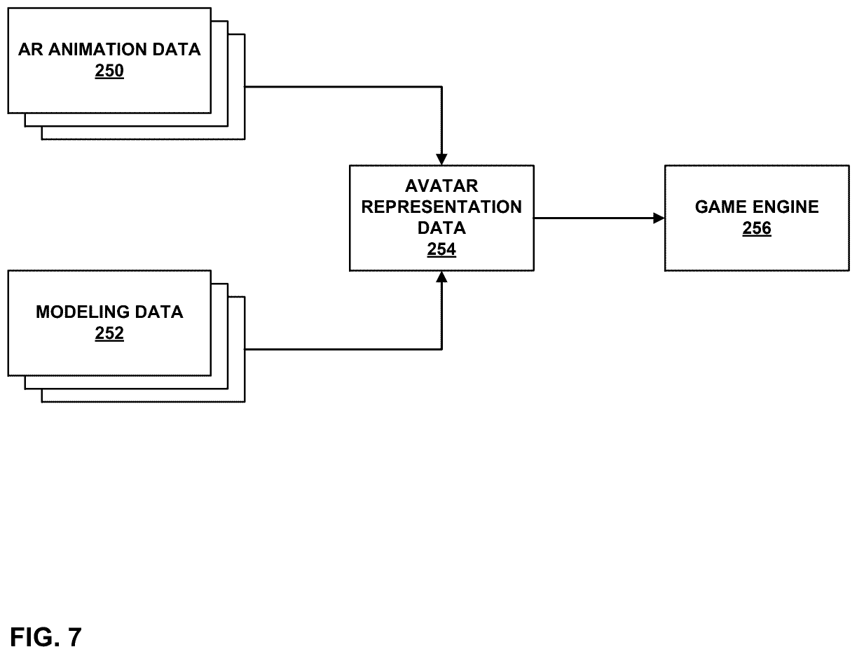

FIG. 7 is a conceptual diagram illustrating an example set of data that may be used in an AR session per techniques of this disclosure. In this example, FIG. 7 depicts AR animation data 250, modeling data 252, avatar representation data 254, and game engine 256. Modeling data 252 may represent one or more sets of data used to form a base avatar model, which may originate from various sources, such as modeling software (e.g., Blender or Maya), glTF, universal scene description (USD), VRM Consortium, MetaHuman, or the like. AR animation data 250 may represent one or more tracked movements of a user to be used to animate the base model, which may originate from OpenXR, ARKit, MediaPipe, or the like. The combination of the base model and the animation data may be formed into avatar representation data 254, which game engine 256 may use to display an animated avatar. Game engine 256 may represent Unreal Engine, Unity Engine, Godot Engine, 3GPP, or the like.

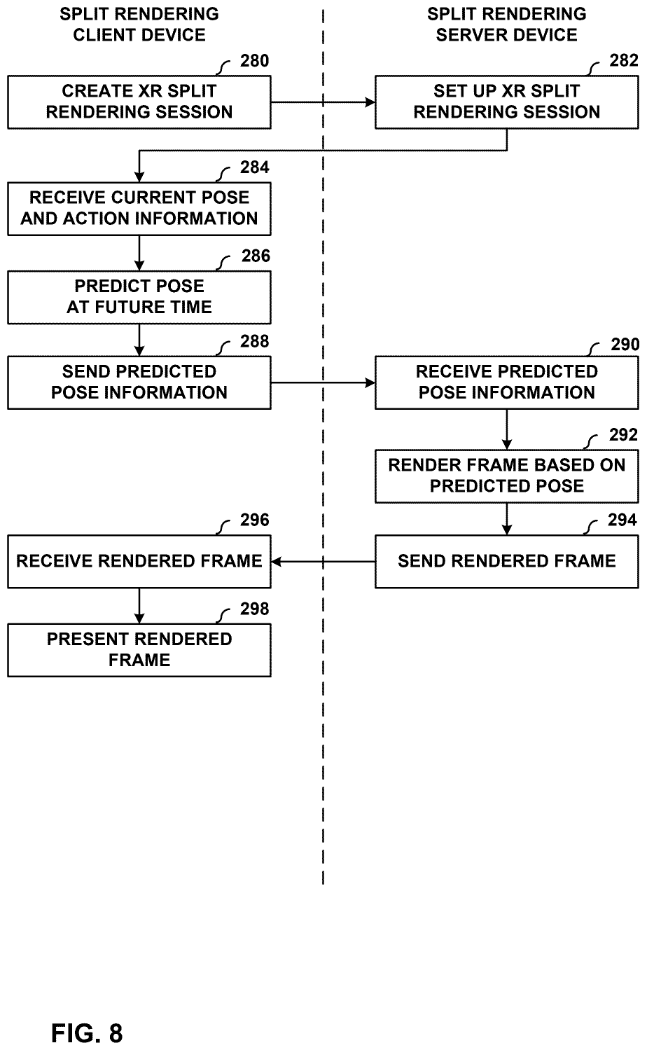

FIG. 8 is a flowchart illustrating an example method of performing split rendering according to techniques of this disclosure. The method of FIG. 8 is performed by a split rendering client device, such as XR client device 140 of FIG. 2, in conjunction with a split rendering server device, such as XR server device 110 of FIG. 2.

Initially, the split rendering client device creates an XR split rendering session (280). As discussed above, creating the XR split rendering session may include, for example, sending device information and capabilities, such as supported decoders, viewport information (e.g., resolution, size, etc.), or the like. Furthermore, per techniques of this disclosure, the split rendering client device may send data indicating an amount of support for AR/XR processing provided by the split rendering client device. The split rendering server device sets up an XR split rendering session (282), which may include setting up encoders corresponding to the decoders and renderers corresponding to the viewport supported by the split rendering client device. The split rendering client device may also establish an AR/XR communication session with another client device.

The split rendering client device may then receive current pose and action information (284). For example, the split rendering client device may collect XR pose and movement information from tracking/XR sensors (e.g., tracking/XR sensors 146 of FIG. 2). The split rendering client device may then predict a user pose (e.g., position and orientation) at a future time (286). The split rendering client device may predict the user pose according to a current position and orientation, velocity, and/or angular velocity of the user/a head mounted display (HMD) worn by the user. The predicted pose may include a position in an XR scene, which may be represented as an {X, Y, Z} triplet value, and an orientation/rotation, which may be represented as an {RX, RY, RZ, RW} quaternion value. The split rendering client device may send the predicted pose information, (optionally) along with any actions performed by the user to the split rendering server device (288). For example, the split rendering client device may form a message according to the format shown in FIG. 8 to indicate the position, rotation, timestamp (indicative of a time for which the pose information was predicted), and optional action information, and send the message to the split rendering server device.

The split rendering server device may receive the predicted pose information (290) from the split rendering client device. The split rendering server device may then render a frame for the future time based on the predicted pose at that future time (292). For example, the split rendering server device may execute a game engine that uses the predicted pose at the future time to render an image for the corresponding viewport, e.g., based on positions of virtual objects in the XR scene relative to the position and orientation of the user's pose at the future time. The split rendering server device may then send the rendered frame to the split rendering client device (294).

The split rendering client device may then receive the rendered frame (296) and present the rendered frame at the future time (298). For example, the split rendering client device may receive a stream of rendered frames and store the received rendered frames to a frame buffer. At a current display time, the split rendering client device may determine the current display time and then retrieve one of the rendered frames from the buffer having a presentation time that is closest to the current display time.

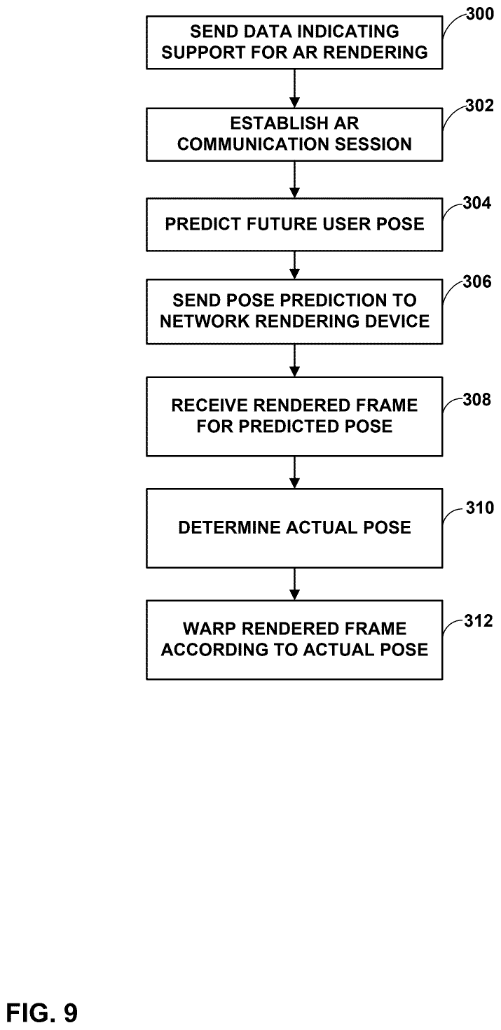

FIG. 9 is a flowchart illustrating an example method for communicating augmented reality (AR) media data according to techniques of this disclosure. The method of FIG. 9 may be performed by a UE device, such as UE 14 of FIG. 1, XR client device 140 of FIG. 2, UE 182 or UE 184 of FIG. 4, UE device 200 of FIG. 5, or receiving device 240 of FIG. 6. For purposes of example, the method of FIG. 9 is explained with respect to UE device 14 of FIG. 1.

In this example, initially, UE device 14 sends data indicating support for AR rendering (300) to AR AS 22. The data generally indicates whether UE device 14 is able to fully or partially process AR media data, or not at all capable of processing AR media data. The data may correspond to a contact header field including a field having a value for a parameter representing the amount of support for AR processing provided by UE device 14 For example, the data may indicate that UE device 14 is fully capable of receiving and rendering AR media data.

As another example, the data may indicate that UE device 14 is capable of transmitting AR metadata on an uplink to AR AS 22 (or to MRF device 26), but that UE device 14 has no support for processing and rendering a 3D scene from the AR media data, such that participation in an AR communication session requires deployment of network rendering by rendering unit 24 of AR AS 22, and that one or more rendered views may be controlled by pose information that is shared by UE device 14. In such a case, UE device 14 may negotiate a partial rendering configuration with AR AS 22. UE device 14 may, for example, exchange data for the partial rendering configuration via a multimedia telephony service over IMS (MTSI) data channel with AR AS 22.

UE device 14 may then establish an AR communication session (302), e.g., with UE device 12 of FIG. 1. During the AR communication session, UE device 14 may predict a future user pose (304) for a user of UE device 14. For example, UE device 14 may include various sensors, such as image sensors, LiDAR sensors, gyroscopes, accelerometers, or the like, which may track changes in position, rotation, orientation, or the like of the user. Thus, based on a current velocity or acceleration of the user's position and orientation, UE device 14 may predict pose information for the user at a future time. UE device 14 may send pose prediction data to a network rendering device (306), e.g., via MRF device 26 or directly to AR AS 22.

UE device 14 may then receive a rendered frame for the predicted pose (308). In the example of FIG. 9, UE device 14 further determines an actual pose of the user (310) at the time at which the rendered frame is to be presented. UE device 14 may then warp the rendered frame according to differences between the predicted pose and the actual pose (312).

In this manner, the method of FIG. 9 represents an example of a method of communicating augmented reality (AR) media data, including: sending, by a first client device that is communicatively coupled to a radio access network (RAN), data to a network device of the RAN, the data indicating an amount of support for AR processing provided by the first client device; establishing, by the first client device, an AR communication session with a second client device; and exchanging, by the first client device, AR media data with the second client device according to the amount of support for AR processing provided by the first client device.

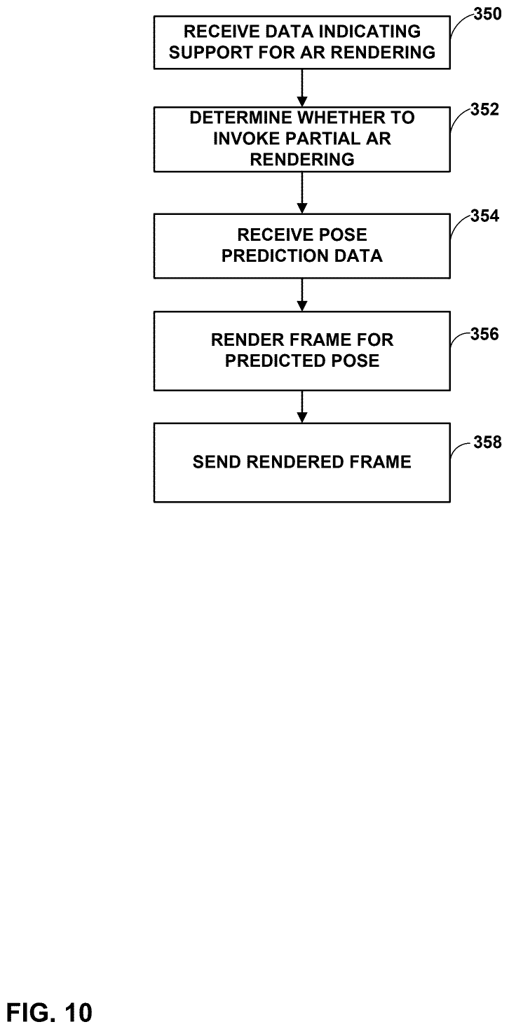

FIG. 10 is a flowchart illustrating an example method for communicating augmented reality (AR) media data according to techniques of this disclosure. The method of FIG. 10 may be performed by a network rendering device, such as AR AS 22 of FIG. 1, XR server device 110, network rendering device 239 of FIG. 6, or the like. For purposes of explanation, the method of FIG. 10 is explained with respect to AR AS 22 of FIG. 1.

Initially, AR AS 22 receives data indicating support for AR processing (e.g., AR media rendering) (350) from a UE device, such as UE device 14 of FIG. 1. Using this data, AR AS 22 may determine whether to invoke partial AR rendering (352) on behalf of UE device 14. Assuming that AR AS 22 determines to perform partial AR rendering, AR AS device 22 may receive pose prediction data from UE device 14 (354). AR AS 22 may then render a frame from AR media data for the predicted pose (356). For example, AR AS 22 may receive animation data for a user avatar of another UE device, such as UE device 12, and animate the avatar accordingly to generate frames of video data from the perspective of the pose of the user of UE device 14. AR AS 22 may then send the rendered frame to UE device 14 (358).

In this manner, the method of FIG. 10 represents an example of a method of communicating augmented reality (AR) media data, including: receiving, by an AR application server (AS) device and from a first client device, data indicating an amount of support for AR processing provided by the first client device; determining, based on the amount of support for AR processing indicated by the data of the request, whether to invoke at least partial rendering of AR media data of an AR communication session on behalf of the first client device; and in response to determining to invoke the at least partial rendering of the AR media data, at least partially rendering the AR media data on behalf of the first client device and sending the at least partially rendered AR media data to the first client device.

Various examples of the techniques of this disclosure are summarized in the following clauses:

Clause 1: A method of communicating augmented reality (AR) media data, the method comprising: sending, by a first client device, a request to participate in an AR communication session with a second client device, the request indicating an amount of support for AR provided by the first client device; establishing, by the first client device, the AR communication session with the second client device; and exchanging, by the first client device, AR media data with the second client device according to the amount of support for AR provided by the first client device.

Clause 2: The method of clause 1, wherein sending the request comprises sending the request to an AR application server (AR AS) to cause the AR AS to determine whether to invoke transcoding on behalf of the first client device.

Clause 3: The method of any of clauses 1 and 2, wherein the request indicates that the first client device provides full support for AR, and wherein exchanging AR media data with the second client device comprises receiving, by the first client device, AR media data from the second client device.

Clause 4: The method of any of clauses 1 and 2, wherein the request indicates that the first client device provides partial support for AR, and wherein exchanging AR media data with the second client device comprises receiving partially rendered AR media data from a split rendering server device.

Clause 5: The method of clause 4, further comprising negotiating, by the first client device, a partial rendering configuration with the split rendering server device.

Clause 6: The method of any of clauses 4 and 5, wherein the split rendering server device comprises an AR application server (AR AS) device.

Clause 7: The method of any of clauses 4-6, further comprising: predicting, by the first client device, a predicted pose of a user of the first client device; and sending, by the first client device, data representing the predicted pose to a multimedia resource function (MRF).

Clause 8: The method of clause 7, wherein the partially rendered AR media data corresponds to the predicted pose, the method further comprising: determining an actual pose of the user of the first client device; and warping the partially rendered AR media data according to the actual pose.

Clause 9: The method of any of clauses 1 and 2, wherein the request indicates that the first client device provides no support for AR, and wherein exchanging AR media data with the second client device comprises receiving network rendered media data from an AR application server (AR AS) device.

Clause 10: The method of any of clauses 1-9, wherein the request includes a contact header field including a field having a value for a parameter representing the amount of support for AR provided by the first client device.

Clause 11: A device for communicating media data, the device comprising one or more means for performing the method of any of clauses 1-10.

Clause 12: The device of clause 11, wherein the one or more means comprise a processing system comprising one or more processors implemented in circuitry, and a memory configured to store AR media data.

Clause 13: A first client device for communicating media data, the first client device comprising: means for sending a request to participate in an AR communication session with a second client device, the request indicating an amount of support for AR provided by the first client device; means for establishing the AR communication session with the second client device; and means for exchanging AR media data with the second client device according to the amount of support for AR provided by the first client device.

Clause 14: A method of communicating augmented reality (AR) media data, the method comprising: receiving, by an AR application server (AS) device, a request from a first client device to participate in an AR communication session with a second client device, the request indicating an amount of support for AR provided by the first client device; determining, based on the amount of support for AR as indicated by the request, whether to invoke at least partial rendering of AR media data on behalf of the first client device; and in response to determining to invoke the at least partial rendering of the AR media data, at least partially rendering the AR media data on behalf of the first client device and sending the at least partially rendered AR media data to the first client device.

Clause 15: The method of clause 14, wherein the request indicates that the first client device provides full support for AR, and wherein determining comprises determining not to perform any rendering of the AR media data on behalf of the first client device.

Clause 16: The method of clause 14, wherein the request indicates that the first client device provides partial support for AR, and wherein determining comprises determining to invoke partial rendering of the AR media data.

Clause 17: The method of clause 14, wherein the request indicates that the first client device provides no support for AR, and wherein determining comprises determining to invoke full rendering of the AR media data.

Clause 18: The method of any of clauses 16 and 17, further comprising negotiating a rendering configuration with the first client device.

Clause 19: The method of any of clauses 16-18, further comprising receiving data representing a predicted pose of a user of the first client device, wherein at least partially rendering the AR media data comprises at least partially rendering the AR media data based on the predicted pose.

Clause 20: The method of any of clauses 14-19, wherein the request includes a contact header field including a field having a value for a parameter representing the amount of support for AR provided by the first client device.

Clause 21: A device for communicating media data, the device comprising one or more means for performing the method of any of clauses 14-20.

Clause 22: The device of clause 21, wherein the one or more means comprise a processing system comprising one or more processors implemented in circuitry, and a memory configured to store AR media data.

Clause 23: A device for communicating media data, the device comprising: means for receiving a request from a first client device to participate in an augmented reality (AR) communication session with a second client device, the request indicating an amount of support for AR provided by the first client device; means for determining, based on the amount of support for AR as indicated by the request, whether to invoke at least partial rendering of AR media data on behalf of the first client device; and means for at least partially rendering the AR media data on behalf of the first client device in response to determining to invoke the at least partial rendering of the AR media data; and means for sending the at least partially rendered AR media data to the first client device in response to determining to invoke the at least partial rendering of the AR media data.

Clause 24: A method of communicating augmented reality (AR) media data, the method comprising: sending, by a first client device that is communicatively coupled to a radio access network (RAN), data to a network device of the RAN, the data indicating an amount of support for AR processing provided by the first client device; establishing, by the first client device, an AR communication session with a second client device; and exchanging, by the first client device, AR media data with the second client device according to the amount of support for AR processing provided by the first client device.

Clause 25: The method of clause 24, wherein sending the data to the network device comprises sending the data to an AR application server (AR AS) of the RAN to cause the AR AS to determine whether to invoke transcoding or rendering of the AR media data on behalf of the first client device.

Clause 26: The method of any of clauses 24 and 25, wherein the data sent to the network device indicates that the first client device provides full support for AR processing, and wherein exchanging the AR media data with the second client device comprises receiving, by the first client device, the AR media data from the second client device.

Clause 27: The method of clause 26, wherein the data sent to the network device indicates that the first client device is fully capable of receiving and rendering AR media.

Clause 28: The method of any of clauses 24 and 25, wherein the data sent to the network device indicates that the first client device provides partial support for AR processing, and wherein exchanging the AR media data with the second client device comprises receiving partially rendered AR media data from a split rendering server device of the RAN, the partially rendered AR media data corresponding to AR media data originating from the second client device.

Clause 29: The method of clause 28, wherein the data sent to the network device indicates that the first client device is capable of transmitting AR metadata on an uplink to the RAN, but that the first client device has no support for processing and rendering a 3D scene from the AR media data, such that participation in the AR communication session requires deployment of network rendering, and that one or more rendered views are controlled by pose information that is shared by the first client device.

Clause 30: The method of any of clauses 28 and 29, further comprising negotiating, by the first client device, a partial rendering configuration with the split rendering server device.

Clause 31: The method of clause 30, wherein negotiating comprises exchanging data for the partial rendering configuration via a multimedia telephony service over IMS (MTSI) data channel.

Clause 32: The method of any of clauses 28-31, wherein the split rendering server device comprises an AR application server (AR AS) device.

Clause 33: The method of any of clauses 28-32, further comprising: predicting, by the first client device, a predicted pose of a user of the first client device; and sending, by the first client device, data representing the predicted pose to a multimedia resource function (MRF) device of the RAN.

Clause 34: The method of clause 33, wherein the partially rendered AR media data corresponds to the predicted pose, the method further comprising: determining an actual pose of the user of the first client device; and warping the partially rendered AR media data according to the actual pose.

Clause 35: The method of any of clauses 24 and 25, wherein the data sent to the network device indicates that the first client device provides no support for AR processing, and wherein exchanging the AR media data with the second client device comprises receiving rendered media data from an AR application server (AR AS) device of the RAN.

Clause 36: The method of any of clauses 24-35, wherein the data sent to the network device includes a contact header field including a field having a value for a parameter representing the amount of support for AR processing provided by the first client device.

Clause 37: A device for communicating media data, the device comprising one or more means for performing the method of any of clauses 1-36.

Clause 38: The device of clause 37, wherein the one or more means comprise a processing system comprising one or more processors implemented in circuitry, and a memory configured to store AR media data.

Clause 39: A first client device for communicating media data via a radio access network (RAN), the first client device comprising: a memory configured to store AR media data; and a processing system implemented in circuitry and configured to: send data to a network device of the RAN, the data indicating an amount of support for AR processing provided by the first client device; establish an AR communication session with a second client device; and exchange AR media data with the second client device according to the amount of support for AR processing provided by the first client device.

Clause 40: The first client device of clause 39, wherein to send the data to the network device, the processing system is configured to send the data to an AR application server (AR AS) of the RAN to cause the AR AS to determine whether to invoke transcoding or rendering of the AR media data on behalf of the first client device.

Clause 41: The first client device of any of clauses 39 and 40, wherein the data sent to the network device indicates that the first client device provides full support for AR processing, and wherein to exchange the AR media data with the second client device, the processing system is configured to receive the AR media data from the second client device.

Clause 42: The first client device of any of clauses 39 and 40, wherein the data sent to the network device indicates that the first client device provides partial support for AR processing, and wherein to exchange the AR media data with the second client device, the processing system is configured to receive partially rendered AR media data from a split rendering server device of the RAN, the partially rendered AR media data corresponding to AR media data originating from the second client device.

Clause 43: The first client device of clause 42, wherein the processing system is further configured to negotiate a partial rendering configuration with the split rendering server device.

Clause 44: The first client device of any of clauses 42 and 43, wherein the split rendering server device comprises an AR application server (AR AS) device.

Clause 45: The first client device of any of clauses 42-44, wherein the processing system is further configured to: predict a predicted pose of a user of the first client device; and send data representing the predicted pose to a multimedia resource function (MRF) device of the RAN.

Clause 46: The first client device of clause 45, wherein the partially rendered AR media data corresponds to the predicted pose, and wherein the processing system is further configured to: determine an actual pose of the user of the first client device; and warp the partially rendered AR media data according to the actual pose.

Clause 47: The first client device of any of clauses 39 and 40, wherein the data sent to the network device indicates that the first client device provides no support for AR processing, and wherein to exchange the AR media data with the second client device, the processing system is configured to receive rendered media data from an AR application server (AR AS) device of the RAN.

Clause 48: The first client device of any of clauses 39-47, wherein the data sent to the network device includes a contact header field including a field having a value for a parameter representing the amount of support for AR processing provided by the first client device.

Clause 49: A first client device for communicating media data via a radio access network (RAN), the first client device comprising: means for sending data to a network device of the RAN, the data indicating an amount of support for AR processing provided by the first client device; means for establishing an AR communication session with a second client device; and means for exchanging AR media data with the second client device according to the amount of support for AR processing provided by the first client device.

Clause 50: A method of communicating augmented reality (AR) media data, the method comprising: receiving, by an AR application server (AS) device, a request from a first client device to participate in an AR communication session with a second client device, the request including data indicating an amount of support for AR processing provided by the first client device; determining, based on the amount of support for AR processing indicated by the data of the request, whether to invoke at least partial rendering of the AR media data on behalf of the first client device; and in response to determining to invoke the at least partial rendering of the AR media data, at least partially rendering the AR media data on behalf of the first client device and sending the at least partially rendered AR media data to the first client device.

Clause 51: The method of clause 50, wherein the request indicates that the first client device provides full support for AR, and wherein determining comprises determining not to perform any rendering of the AR media data on behalf of the first client device.

Clause 52: The method of clause 50, wherein the request indicates that the first client device provides partial support for AR, and wherein determining comprises determining to invoke partial rendering of the AR media data.

Clause 53: The method of clause 50, wherein the request indicates that the first client device provides no support for AR, and wherein determining comprises determining to invoke full rendering of the AR media data.

Clause 54: The method of any of clauses 52 and 53, further comprising negotiating a rendering configuration with the first client device.

Clause 55: The method of any of clauses 52-54, further comprising receiving data representing a predicted pose of a user of the first client device, wherein at least partially rendering the AR media data comprises at least partially rendering the AR media data based on the predicted pose.

Clause 56: The method of any of clauses 50-55, wherein the request includes a contact header field including a field having a value for a parameter representing the amount of support for AR processing provided by the first client device.

Clause 57: A device for communicating media data, the device comprising one or more means for performing the method of any of clauses 50-56.

Clause 58: The device of clause 57, wherein the one or more means comprise a processing system comprising one or more processors implemented in circuitry, and a memory configured to store AR media data.

Clause 59: An augmented reality (AR) application server (AS) device for communicating media data, the device comprising: a memory configured to store AR media data; and a processing system implemented in circuitry and configured to: receive a request from a first client device to participate in an AR communication session with a second client device, the request including data indicating an amount of support for AR processing provided by the first client device; determine, based on the amount of support for AR processing indicated by the data of the request, whether to invoke at least partial rendering of the AR media data on behalf of the first client device; and in response to determining to invoke the at least partial rendering of the AR media data, at least partially render the AR media data on behalf of the first client device and send the at least partially rendered AR media data to the first client device.

Clause 60: The AR AS device of clause 59, wherein the request indicates that the first client device provides full support for AR, and wherein the processing system is configured to determine not to perform any rendering of the AR media data on behalf of the first client device.

Clause 61: The AR AS device of clause 59, wherein the request indicates that the first client device provides partial support for AR, and wherein the processing system is configured to determine to invoke partial rendering of the AR media data.

Clause 62: The AR AS device of clause 59, wherein the request indicates that the first client device provides no support for AR, and wherein the processing system is configured to determine to invoke full rendering of the AR media data.

Clause 63: The AR AS device of any of clauses 61 and 62, wherein the processing system is further configured to negotiate a rendering configuration with the first client device.

Clause 64: The AR AS device of any of clauses 61-63, wherein the processing system is further configured to receive data representing a predicted pose of a user of the first client device, wherein to at least partially render the AR media data, the processing system is configured to at least partially render the AR media data based on the predicted pose.

Clause 65: The AR AS device of any of clauses 59-64, wherein the request includes a contact header field including a field having a value for a parameter representing the amount of support for AR processing provided by the first client device.

Clause 66: An augmented reality (AR) application server (AS) device for communicating media data, the AR AS device comprising: means for receiving a request from a first client device to participate in an AR communication session with a second client device, the request including data indicating an amount of support for AR processing provided by the first client device; means for determining, based on the amount of support for AR processing indicated by the data of the request, whether to invoke at least partial rendering of the AR media data on behalf of the first client device; and means for at least partially rendering the AR media data on behalf of the first client device in response to determining to invoke the at least partial rendering of the AR media data; and means for sending the at least partially rendered AR media data to the first client device in response to determining to invoke the at least partial rendering of the AR media data.

Clause 67: A method of communicating augmented reality (AR) media data, the method comprising: sending, by a first client device that is communicatively coupled to a radio access network (RAN), data to a network device of the RAN, the data indicating an amount of support for AR processing provided by the first client device; establishing, by the first client device, an AR communication session with a second client device; and exchanging, by the first client device, AR media data with the second client device according to the amount of support for AR processing provided by the first client device.

Clause 68: The method of clause 67, wherein sending the data to the network device comprises sending the data to an AR application server (AR AS) of the RAN to cause the AR AS to determine whether to invoke transcoding or rendering of the AR media data on behalf of the first client device.

Clause 69: The method of clause 67, wherein the data sent to the network device indicates that the first client device provides full support for AR processing, and wherein exchanging the AR media data with the second client device comprises receiving, by the first client device, the AR media data from the second client device.

Clause 70: The method of clause 69, wherein the data sent to the network device indicates that the first client device is fully capable of receiving and rendering AR media.

Clause 71: The method of clause 67, wherein the data sent to the network device indicates that the first client device provides partial support for AR processing, and wherein exchanging the AR media data with the second client device comprises receiving partially rendered AR media data from a split rendering server device of the RAN, the partially rendered AR media data corresponding to AR media data originating from the second client device.

Clause 72: The method of clause 71, wherein the data sent to the network device indicates that the first client device is capable of transmitting AR metadata on an uplink to the RAN, but that the first client device has no support for processing and rendering a 3D scene from the AR media data, such that participation in the AR communication session requires deployment of network rendering, and that one or more rendered views are controlled by pose information that is shared by the first client device.

Clause 73: The method of clause 71, further comprising negotiating, by the first client device, a partial rendering configuration with the split rendering server device.

Clause 74: The method of clause 73, wherein negotiating comprises exchanging data for the partial rendering configuration via a multimedia telephony service over IMS (MTSI) data channel.

Clause 75: The method of clause 71, wherein the split rendering server device comprises an AR application server (AR AS) device.

Clause 76: The method of clause 71, further comprising: predicting, by the first client device, a predicted pose of a user of the first client device; and sending, by the first client device, data representing the predicted pose to a multimedia resource function (MRF) device of the RAN.

Clause 77: The method of clause 76, wherein the partially rendered AR media data corresponds to the predicted pose, the method further comprising: determining an actual pose of the user of the first client device; and warping the partially rendered AR media data according to the actual pose.

Clause 78: The method of clause 67, wherein the data sent to the network device indicates that the first client device provides no support for AR processing, and wherein exchanging the AR media data with the second client device comprises receiving rendered media data from an AR application server (AR AS) device of the RAN.

Clause 79: The method of clause 67, wherein the data sent to the network device includes a contact header field including a field having a value for a parameter representing the amount of support for AR processing provided by the first client device.

Clause 80: A first client device for communicating media data via a radio access network (RAN), the first client device comprising: a memory configured to store AR media data; and a processing system implemented in circuitry and configured to: send data to a network device of the RAN, the data indicating an amount of support for AR processing provided by the first client device; establish an AR communication session with a second client device; and exchange AR media data with the second client device according to the amount of support for AR processing provided by the first client device.

Clause 81: The first client device of clause 80, wherein to send the data to the network device, the processing system is configured to send the data to an AR application server (AR AS) of the RAN to cause the AR AS to determine whether to invoke transcoding or rendering of the AR media data on behalf of the first client device.

Clause 82: The first client device of clause 80, wherein the data sent to the network device indicates that the first client device provides full support for AR processing, and wherein to exchange the AR media data with the second client device, the processing system is configured to receive the AR media data from the second client device.

Clause 83: The first client device of clause 80, wherein the data sent to the network device indicates that the first client device provides partial support for AR processing, and wherein to exchange the AR media data with the second client device, the processing system is configured to receive partially rendered AR media data from a split rendering server device of the RAN, the partially rendered AR media data corresponding to AR media data originating from the second client device.

Clause 84: The first client device of clause 83, wherein the processing system is further configured to negotiate a partial rendering configuration with the split rendering server device.

Clause 85: The first client device of clause 83, wherein the split rendering server device comprises an AR application server (AR AS) device.

Clause 86: The first client device of clause 83, wherein the processing system is further configured to: predict a predicted pose of a user of the first client device; and send data representing the predicted pose to a multimedia resource function (MRF) device of the RAN.

Clause 87: The first client device of clause 86, wherein the partially rendered AR media data corresponds to the predicted pose, and wherein the processing system is further configured to: determine an actual pose of the user of the first client device; and warp the partially rendered AR media data according to the actual pose.

Clause 88: The first client device of clause 80, wherein the data sent to the network device indicates that the first client device provides no support for AR processing, and wherein to exchange the AR media data with the second client device, the processing system is configured to receive rendered media data from an AR application server (AR AS) device of the RAN.

Clause 89: The first client device of clause 80, wherein the data sent to the network device includes a contact header field including a field having a value for a parameter representing the amount of support for AR processing provided by the first client device.

Clause 90: A method of communicating augmented reality (AR) media data, the method comprising: receiving, by an AR application server (AS) device, a request from a first client device to participate in an AR communication session with a second client device, the request including data indicating an amount of support for AR processing provided by the first client device; determining, based on the amount of support for AR processing indicated by the data of the request, whether to invoke at least partial rendering of the AR media data on behalf of the first client device; and in response to determining to invoke the at least partial rendering of the AR media data, at least partially rendering the AR media data on behalf of the first client device and sending the at least partially rendered AR media data to the first client device.

Clause 91: The method of clause 90, wherein the request indicates that the first client device provides full support for AR, and wherein determining comprises determining not to perform any rendering of the AR media data on behalf of the first client device.

Clause 92: The method of clause 90, wherein the request indicates that the first client device provides partial support for AR, and wherein determining comprises determining to invoke partial rendering of the AR media data.

Clause 93: The method of clause 92, further comprising negotiating a rendering configuration with the first client device.

Clause 94: The method of clause 92, further comprising receiving data representing a predicted pose of a user of the first client device, wherein at least partially rendering the AR media data comprises at least partially rendering the AR media data based on the predicted pose.

Clause 95: The method of clause 90, wherein the request includes a contact header field including a field having a value for a parameter representing the amount of support for AR processing provided by the first client device.

Clause 96: An augmented reality (AR) application server (AS) device for communicating media data, the device comprising: a memory configured to store AR media data; and a processing system implemented in circuitry and configured to: receive a request from a first client device to participate in an AR communication session with a second client device, the request including data indicating an amount of support for AR processing provided by the first client device; determine, based on the amount of support for AR processing indicated by the data of the request, whether to invoke at least partial rendering of the AR media data on behalf of the first client device; and in response to determining to invoke the at least partial rendering of the AR media data, at least partially render the AR media data on behalf of the first client device and send the at least partially rendered AR media data to the first client device.

Clause 97: The AR AS device of clause 96, wherein the request indicates that the first client device provides full support for AR, and wherein the processing system is configured to determine not to perform any rendering of the AR media data on behalf of the first client device.

Clause 98: The AR AS device of clause 96, wherein the request indicates that the first client device provides partial support for AR, and wherein the processing system is configured to determine to invoke partial rendering of the AR media data.

Clause 99: The AR AS device of clause 98, wherein the processing system is further configured to negotiate a rendering configuration with the first client device.

Clause 100: The AR AS device of clause 98, wherein the processing system is further configured to receive data representing a predicted pose of a user of the first client device, wherein to at least partially render the AR media data, the processing system is configured to at least partially render the AR media data based on the predicted pose.

Clause 101: The AR AS device of clause 96, wherein the request includes a contact header field including a field having a value for a parameter representing the amount of support for AR processing provided by the first client device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating augmented reality (AR) media data, the method comprising:
sending, by a first client device that is communicatively coupled to a radio access network (RAN), data to a network device of the RAN, the data indicating an amount of support for AR processing provided by the first client device;
establishing, by the first client device, an AR communication session with a second client device; and
exchanging, by the first client device, AR media data with the second client device according to the amount of support for AR processing provided by the first client device.

2. The method of claim 1, wherein sending the data to the network device comprises sending the data to an AR application server (AR AS) of the RAN to cause the AR AS to determine whether to invoke transcoding or rendering of the AR media data on behalf of the first client device.

3. The method of claim 1, wherein the data sent to the network device indicates that the first client device is fully capable of receiving and rendering the AR media data, and wherein exchanging the AR media data with the second client device comprises receiving, by the first client device, the AR media data from the second client device.

4. The method of claim 1, wherein the data sent to the network device indicates that the first client device is capable of transmitting AR metadata on an uplink to the RAN, but that the first client device has no support for processing and rendering a 3D scene from the AR media data, such that participation in the AR communication session requires deployment of network rendering, and that one or more rendered views are controlled by pose information that is shared by the first client device, and wherein exchanging the AR media data with the second client device comprises receiving partially rendered AR media data from an AR application server (AR) device configured as a split rendering server device of the RAN, the partially rendered AR media data corresponding to AR media data originating from the second client device.

5. The method of claim 4, further comprising negotiating, by the first client device, a partial rendering configuration with the AR AS device, including exchanging data for the partial rendering configuration via a multimedia telephony service over IMS (MTSI) data channel.

6. The method of claim 4, further comprising:
predicting, by the first client device, a predicted pose of a user of the first client device; and
sending, by the first client device, data representing the predicted pose to a multimedia resource function (MRF) device of the RAN.

7. The method of claim 6, wherein the partially rendered AR media data corresponds to the predicted pose, the method further comprising:
determining an actual pose of the user of the first client device; and
warping the partially rendered AR media data according to the actual pose.

8. The method of claim 1, wherein the data sent to the network device indicates that the first client device provides no support for AR processing, and wherein exchanging the AR media data with the second client device comprises receiving rendered media data from an AR application server (AR AS) device of the RAN.

9. The method of claim 1, wherein the data sent to the network device comprises a session initiation protocol (SIP) feature tag including a contact header field, the contact header field including a field having a value for a parameter representing the amount of support for AR processing provided by the first client device.

10. A first client device for communicating media data via a radio access network (RAN), the first client device comprising:
a memory configured to store AR media data; and
a processing system implemented in circuitry and configured to:
send data to a network device of the RAN, the data indicating an amount of support for AR processing provided by the first client device;
establish an AR communication session with a second client device; and
exchange AR media data with the second client device according to the amount of support for AR processing provided by the first client device.

11. The first client device of claim 10, wherein to send the data to the network device, the processing system is configured to send the data to an AR application server (AR AS) of the RAN to cause the AR AS to determine whether to invoke transcoding or rendering of the AR media data on behalf of the first client device.

12. The first client device of claim 10, wherein the data sent to the network device indicates that the first client device provides full support for AR processing, and wherein to exchange the AR media data with the second client device, the processing system is configured to receive the AR media data from the second client device.

13. The first client device of claim 10, wherein the data sent to the network device indicates that the first client device provides partial support for AR processing, and wherein to exchange the AR media data with the second client device, the processing system is configured to receive partially rendered AR media data from a split rendering server device of the RAN, the partially rendered AR media data corresponding to AR media data originating from the second client device.

14. The first client device of claim 13, wherein the processing system is further configured to negotiate a partial rendering configuration with the split rendering server device.

15. The first client device of claim 13, wherein the split rendering server device comprises an AR application server (AR AS) device.

16. The first client device of claim 13, wherein the processing system is further configured to:
predict a predicted pose of a user of the first client device; and
send data representing the predicted pose to a multimedia resource function (MRF) device of the RAN.

17. The first client device of claim 16, wherein the partially rendered AR media data corresponds to the predicted pose, and wherein the processing system is further configured to:
determine an actual pose of the user of the first client device; and
warp the partially rendered AR media data according to the actual pose.

18. The first client device of claim 10, wherein the data sent to the network device comprises a session initiation protocol (SIP) feature tag including a contact header field, the contact header field including a field having a value for a parameter representing the amount of support for AR processing provided by the first client device.

19. A method of communicating augmented reality (AR) media data, the method comprising:
receiving, by an AR application server (AS) device and from a first client device, data indicating an amount of support for AR processing provided by the first client device;
determining, based on the amount of support for AR processing indicated by the data, whether to invoke at least partial rendering of AR media data of an AR communication session on behalf of the first client device; and
in response to determining to invoke the at least partial rendering of the AR media data, at least partially rendering the AR media data on behalf of the first client device and sending the at least partially rendered AR media data to the first client device.

20. The method of claim 19, wherein the data indicates that the first client device provides full support for AR, and wherein determining comprises determining not to perform any rendering of the AR media data on behalf of the first client device.

21. The method of claim 19, wherein the data indicates that the first client device provides partial support for AR, and wherein determining comprises determining to invoke partial rendering of the AR media data.

22. The method of claim 21, further comprising negotiating a rendering configuration with the first client device.

23. The method of claim 21, further comprising receiving data representing a predicted pose of a user of the first client device, wherein at least partially rendering the AR media data comprises at least partially rendering the AR media data based on the predicted pose.

24. The method of claim 19, wherein the data comprises a session initiation protocol (SIP) feature tag including a contact header field, the contact header field including a field having a value for a parameter representing the amount of support for AR processing provided by the first client device.

25. An augmented reality (AR) application server (AS) device for communicating media data, the device comprising:
a memory configured to store AR media data; and
a processing system implemented in circuitry and configured to:
receive, from a first client device, data indicating an amount of support for AR processing provided by the first client device;
determine, based on the amount of support for AR processing indicated by the data, whether to invoke at least partial rendering of AR media data of an AR communication session on behalf of the first client device; and
in response to determining to invoke the at least partial rendering of the AR media data, at least partially render the AR media data on behalf of the first client device and send the at least partially rendered AR media data to the first client device.

26. The AR AS device of claim 25, wherein the data indicates that the first client device provides full support for AR, and wherein the processing system is configured to determine not to perform any rendering of the AR media data on behalf of the first client device.

27. The AR AS device of claim 25, wherein the data indicates that the first client device provides partial support for AR, and wherein the processing system is configured to determine to invoke partial rendering of the AR media data.

28. The AR AS device of claim 27, wherein the processing system is further configured to negotiate a rendering configuration with the first client device.

29. The AR AS device of claim 27, wherein the processing system is further configured to receive data representing a predicted pose of a user of the first client device, wherein to at least partially render the AR media data, the processing system is configured to at least partially render the AR media data based on the predicted pose.

30. The AR AS device of claim 25, wherein the data comprises a session initiation protocol (SIP) feature tag including a contact header field, the contact header field including a field having a value for a parameter representing the amount of support for AR processing provided by the first client device.
